(19) United States
(12) Patent Application Publication
(10) Pub. No.: US 2007/0041880 A1
(43) Pub. Date: Feb. 22, 2007

(54) Exhaust treatment device

(76) Inventors: Bernd Reinsch, Ludwigsburg (DE); Teruo Komori, Stuttgart (DE); Lars Thuener, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/557,783

(22) PCT Filed: Dec. 20, 2003
(86) PCT No.: PCT/DE04/02555

§ 371 Date: Nov. 18, 2005

(30) Foreign Application Priority Data
Dec. 20, 2003 (DE) 103 60 254.2
Nov. 4, 2004 (DE) 10 2004 053 267.2

(51) Int. Cl. B01D 50/00

(52) U.S. Cl. 422/177

(57) ABSTRACT

An exhaust treatment device and a carrying structure for treating the exhaust of an internal combustion engine, in particular an autoignition internal combustion engine of a motor vehicle, as well as a method for manufacturing a corresponding device, having a support structure, in which the exhaust is able to interact with the support structure in order to treat the exhaust and in which a fiber layer is situated on the surface of the support structure. The fiber layer improves the contact of the exhaust with the surface of the exhaust treatment device.

### FIELD OF THE INVENTION

The present invention is based on an exhaust treatment device and a method for manufacturing the exhaust treatment device according to the preamble to the independent claims. It is known to reduce the nitrogen in exhaust from motor vehicles by means of NOx catalytic converters and to reduce the amount of particulate matter in the exhaust by means of a particulate filter. In some cases, catalytic layers are used in this connection to improve the oxidation of CO and hydrocarbons in diesel oxidizing converters and to improve particulate matter regeneration in diesel particulate filters. It is known, for example from WO 01/36097 A1, to apply catalytic layers (layers that contain an active material, namely a catalyst material) onto a base structure, often together with a coating that increases the surface area due to its uneven surface, a so-called washcoat. Technically, this can be accomplished in the following manner. In a first step, the entire support for the catalytic layer is covered with a relatively thick base layer of washcoat and then in a second step, a thin coat of active material is added to the surface. The disadvantage of this technique lies in the fact that although a particular surface is in fact produced, the structure still remains a more or less flat layer on the filter material. The usable quantity of washcoat is limited due to the increasing back pressure.

### ADVANTAGES OF THE INVENTION

The exhaust treatment device and carrying structure according to the present invention and the method according to the invention for manufacturing the exhaust treatment device, with the characterizing features of the independent claims, have the advantage over the prior art that the fiber-rich surface layer makes it possible to produce a highly porous surface structure with a large amount of surface area with which the present invention is able to: improve the pressure drop behavior, particularly in particulate matter-laden sintered metal filters, by reducing the increase in exhaust back pressure during particulate matter loading; to achieve a good gas/solid contact; to permit a better contact for the oxidation of the exhaust and particulate matter; and to provide a larger surface area for catalytic coatings, in particular in diesel oxidizing converters integrated into sintered metal filters or in NOx catalytic converters. In order to obtain the best performance, it is very important for there to be good contact between the exhaust or the deposited particulate matter and the exhaust treatment device or the filter or catalytic converter; this contact is advantageously promoted in that, in comparison to a base surface of the carrying structure, its effective surface area is increased through a three-dimensional embodiment of the effective surface area. All of this is assured with a device that is easy to manufacture.

Advantageous modifications and improvements of the exhaust treatment device, the support structure, and the above-mentioned method for manufacturing the exhaust treatment device that are disclosed in the independent claims are possible by means of the measures taken in the dependent claims. The use of sintered metal to construct the exhaust treatment device assures a robust, long-lived device even under extreme thermal conditions, in particular permitting a flexible choice of the design of a device of this kind in comparison to ceramic devices, in which the design freedom is limited by the production methods currently in use, namely continuous casting of the ceramic body.

If the exhaust treatment device is embodied in the form of a particulate filter using sintered metal, this has a longer service life than comparable ceramic filters. Because of the design freedom, the filter structure can be selected so that in a constantly required regeneration of the filter in order to burn off the collected particulate matter, the bum-off of particulate matter is started in several locations at the same time and not just on one side of the filter as is normally the case in ceramic filters. This results in a thermal load that is better balanced and therefore extends the service life. In particular, the advantage of an increased service life is also achieved because the fiber layer increases the ash storage volume. Ash is the sum of the residues that remain in the particulate filter even after filter regeneration, collecting over many regeneration cycles and finally causing the filter to become “ash clogged”. The fiber layer can advantageously delay this ash clogging. The exhaust back pressure of a sintered metal filter is advantageously reduced due to a synergy effect with the combination of a fiber layer having a deep bed filter action and the surface filter made of sintered metal. The fiber layer functioning as a deep bed filter does not generate any filter cake that closes the interconnected pores of the fiber layer, which assures the development of only a slight exhaust back pressure, even when the particulate filter and the flow-through filtering device have already reached an advanced age. This is advantageously combined with the fact that the boundary layer between the fiber layer and the sintered metal volume functions as a surface filter with a high filtration efficiency. In addition, even without using catalytic material, a low layer thickness yields a highly active surface, integrated into a mechanically robust and stable device or support structure.

In the case of a sintered metal particulate filter with pockets made of sintered metal, the filter pockets can thus be situated much closer to one another without falling below a certain minimum distance between the walls of adjacent filter pockets, particularly at the downstream end of a filter according to DE 102 23 452 A1, which can allow the exhaust back pressure to rise slightly.

If the exhaust treatment device is manufactured with sintered metal walls of varying thickness, in particular comprised of a metal screen with openings that are only partially filled with sintered metal, then in addition to a material savings in sintered metal, this also yields a more compact arrangement that can be positioned even closer to an adjacent sintered metal wall and nevertheless leaves enough free space to limit the exhaust back pressure to an acceptable level during the entire service life of the exhaust treatment device, despite the accumulation of a so-called filter cake composed of ash in the case of a particulate filter. In addition, the exhaust back pressure is further reduced without having to accept losses in filtration efficiency.

If a high degree of porosity is selected, then in the case of the particulate filter, the large volume layer with a high degree of porosity yields a particularly loose, more intensely reactive depositing of the particulate matter. An embodiment form of this kind is therefore particularly advantageous in its suitability for collecting and loosely storing particulate matter.

Particularly with a three-dimensional arrangement of the fibers, a large, active surface area is advantageously achieved and optionally, with the application or introduction of catalytic materials, an intense catalytic activity and therefore an effective purification of the exhaust are also achieved due to a large three-dimensional surface area and a good contact between the particular matter or gas and the catalyst; this results in a relatively low NO₂/particulate matter bum-off temperature (balance point temperature), a low regeneration temperature, a short regeneration, an increase in the volume of washcoat that can be applied (e.g. in an integrated diesel oxidizing converter (DOC), to sintered metal filters (SMF), and/or an NOx catalytic converter coating.

The washcoat advantageously increases the adhesion between catalytically active material and the fiber structure and, in the case of fibers coated with washcoat, further increases the active fiber surface area. It is also advantageous that when a washcoat is used to bond the fibers, a specific bonding agent is no longer required, which simplifies the manufacture and makes it less expensive.

The use of coarse fibers advantageously yields a large active fiber surface area.

If the fiber layer is applied in the form of a non-woven fabric and/or a fiber mat, then regardless of the support structure/filter, the fiber structure can advantageously be manufactured ahead of time in the form of a highly porous fiber mat that is then applied to the filter surface. This yields a simple technical implementation and handling, particularly also when the fiber layer is coated or mixed with a catalytically active material, because the fiber mat only constitutes a fraction of the overall weight of a filter and is therefore easy transport in comparison to an entire filter structure. Furthermore, it can be used in a wide variety of applications. The fiber mat and therefore the fiber layer on the sintered metal can be exactly set up and inspected ahead of time in terms of geometry, in particular layer thickness, but also in terms of chemical and mesoscopic composition. In addition, an exhaust treatment device with a fiber mat has a higher degree of structural stability than a device with fiber layers produced by means of sedimentation. The use of suitable fibers can yield surfaces with very large active surface areas. In particular, the fiber mats can be provided with catalytically active coatings independent of the sintered metal filter: the coatings can be produced on the ceramic material of the fibers, which are easier to coat than metallic supports; the ceramic fibers are more chemically resistant, particularly at high temperatures, than the SMF base material. The catalytic coating is spatially separate from the sintered metal filter and the coating solution (“slurry”) and washcoat have only minimal contact with the steel surface, which makes it possible to avoid chemical attacks such as corrosion. The fibers can be provided with a high degree of washcoat coverage in particular for NOx catalytic converter coatings, without clogging the sintered metal structure with washcoat or slurry in the process, which makes it possible to keep the back pressure of the filter to a minimum. Different coating compositions can be used inside the filter by making use of different previously prepared fiber mats for different pockets.

Fibers with a diameter of 1 to 3 micrometers, in particular from 2 to 3 micrometers, assure a highly active fiber surface while at the same time not presenting a health hazard, avoiding a cancer risk that would otherwise be present if finer fibers were used.

An undulating fiber layer advantageously results in a further increase in the surface area, a higher particulate matter capacity, and a consequently reduced back pressure increase due to the accumulation of particulate matter.

In addition to an exhaust filter or particulate filter and other exhaust treatment devices, the scope of the present invention also includes the fiber layer applied to a support structure and the carrying structure as such.

### Drawings

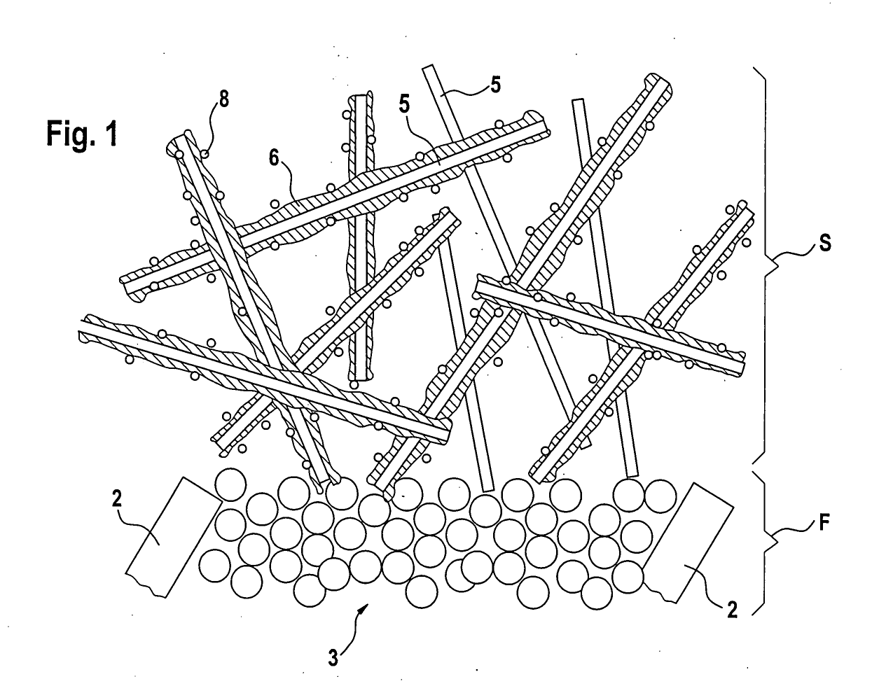

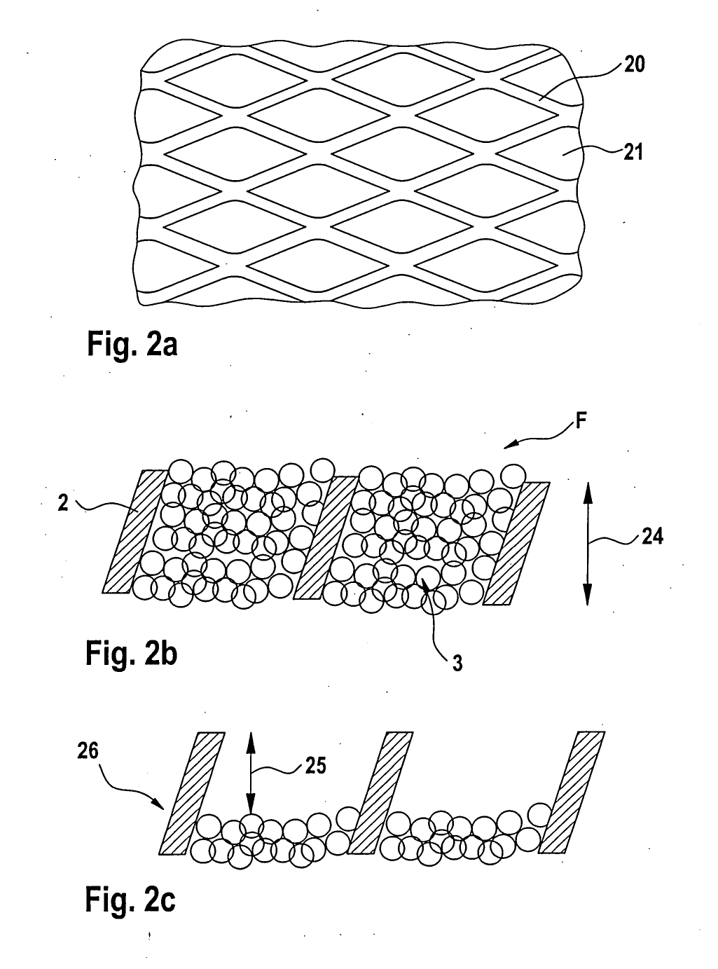

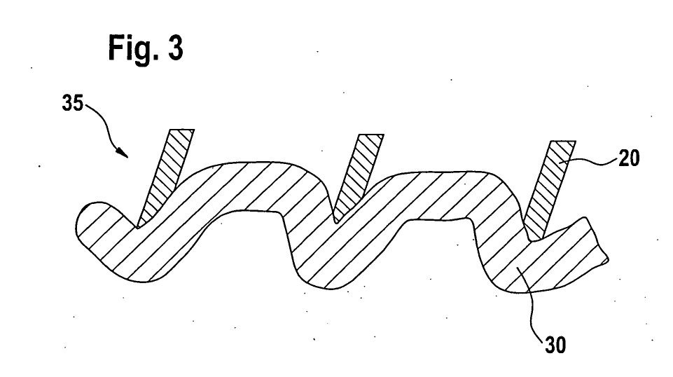

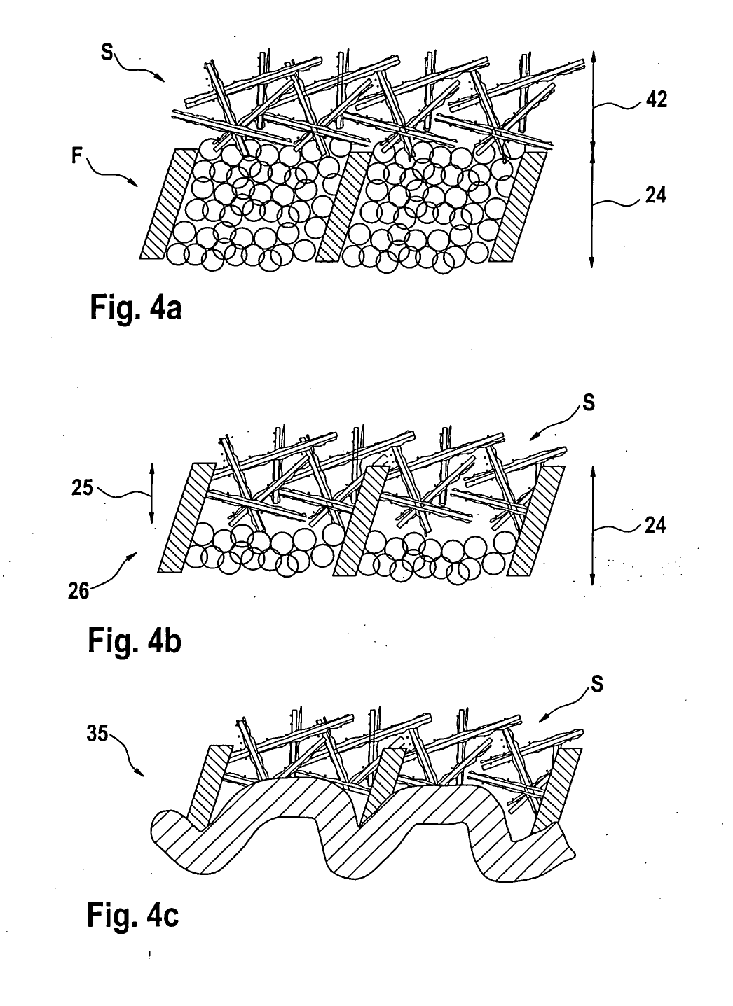

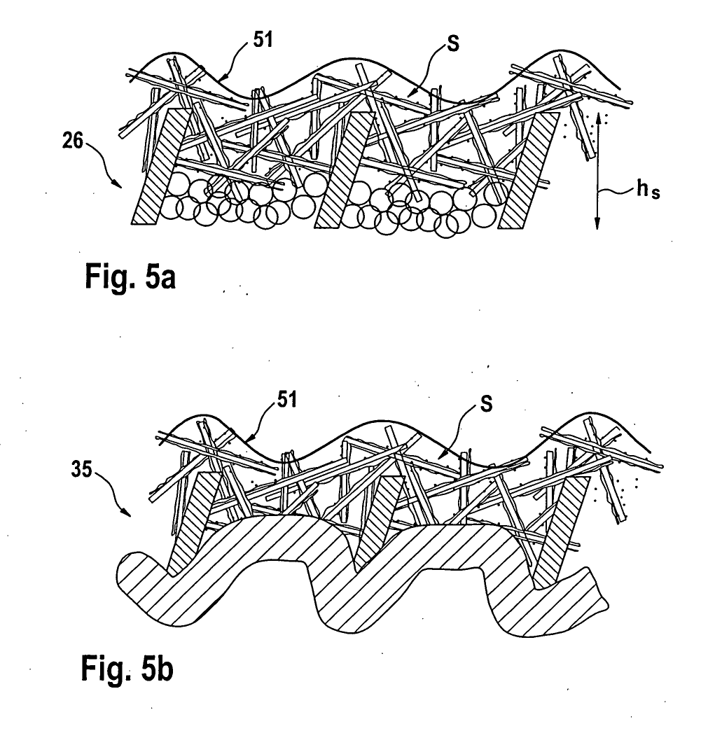

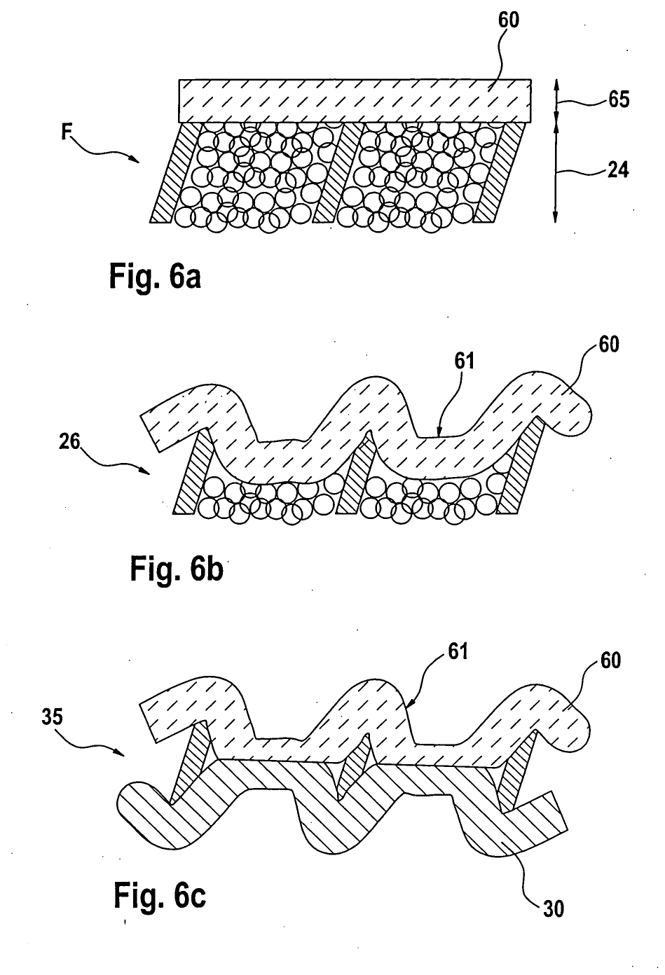

Exemplary embodiments of the exhaust treatment device according to the present invention are shown in the drawings and will be explained in greater detail in the description that follows. The term washcoat here refers partly to the ready-to-use layer and partly to the material of which the actual layer is manufactured. FIG. 1 shows an exemplary embodiment of a part of an exhaust filter according to the present invention with a carrying structure according to the present invention. In a combined depiction that shows a longitudinal section and a perspective view, FIG. 1 schematically depicts a detail of a catalytic converter or a catalytically coated exhaust filter with a three-dimensional carrying structure that is supported on and held by a support structure. FIGS. 2a-c show the designs of various support structures, FIG. 3 shows an alternative design of a support structure, FIGS. 4a-c show fiber-coated support structures, FIGS. 5a-b show fiber-coated support structures with undulating surfaces, and FIGS. 6a-c show support structures with non-woven fiber fabric.

### DESCRIPTION OF THE EXEMPLARY EMBODIMENTS

FIG. 1 shows a special formulation of a washcoat for mainly catalytically coated—but also non-catalytically coated—particulate filter systems based on sintered metal (but also for other particulate filter systems). A chief improvement is the use of a high percentage (ratio) of fibers, in particular long fibers, in the washcoat. When they are applied to or deposited onto filter materials or a support structure, these fibers make it possible to produce highly porous three-dimensional carrying structures for catalytic materials 0.05 mm to 2.0 mm thick, with a porosity of more than 50%. The support structure itself consequently serves as a carrier for a thin layer (or several layers) of washcoat, which serve as a carrying structure for the catalytically active material and have the capacity to stabilize this material (in its spatial position). FIG. 1 shows a support structure F that is part of a catalytic converter for diesel engines. The support structure F has metallic wall segments 2 between which a rigid layer 3 is formed, comprised of metal balls in the example; a three-dimensional carrying structure S rests on this support structure and is sufficiently bonded to it as required for reliable operation of the catalytic converter. The carrying structure S has fibers 5 that are comprised of ceramic in the example. The fibers 5 in the example are straight segments with a limited length. Each individual fiber 5 is shown in a longitudinal section. The individual fibers 5 are situated in a random three-dimensional arrangement. Among other things to increase their surface area, the fibers 5 are almost all covered with a coating, a so-called washcoat 6, which has an irregular outer contour and encompasses the fibers over their entire circumference. Although it is not shown in the drawing, the washcoat can also cover the ends of the fibers 5. Some fibers 5 in the drawing are shown without washcoat; this can occur randomly but can also be an intentional part of the manufacture. On its outside, the washcoat 6 carries an active material 8, namely a catalytic material. This is symbolized in the drawing by means of individual, very small spherules. This is intended to indicate that the active material 8 does not absolutely have to encase all of the fibers over a large area or completely, but rather that it can be sufficient for the active material to be applied to the washcoat in a layer that is more or less intensely broken up. As shown in FIG. 1, if, in a direction at right angles to the plane of the drawing, part of the individual fibers 5 are situated all the way at the bottom, part are situated all the way at the top, and part extend from the very bottom to the very top, then they therefore fill their space in a three-dimensional manner, thus constituting a three-dimensional structure similar to a non-woven fabric. This yields a carrying structure S for an internal combustion engine exhaust filter whose effective surface area is increased in comparison to a base surface of the carrying structure through a three-dimensional embodiment of the effective surface area; the carrying structure can optionally contain active material (namely catalytically active material); the carrying structure S has three-dimensionally oriented fibers 5 that have open-pored cavities between them; and fibers 5 are bonded to one another by means of a bonding agent in the region of their reciprocally adjacent regions.

The cohesion of the fibers 5 is achieved by means of the washcoat 6, which is solid after manufacture, or by means of inorganic bonding materials (bonding agents, see above) in the region of the contact points between the fibers 5. It is not absolutely necessary for all contact points or adjacent regions of the fibers to be bonded to one another. In the example, the layer 3 of the support layer F is comprised of very small metal spherules that are bonded by means of sintering and have open-pored, gas-permeable interstices between them, combining to produce a sintered metal filter (SMF). In the figure, the flow of exhaust to be purified travels from top to bottom. In the example, the carrying layer or carrying structure with the active material situated on it captures particulate matter from the diesel exhaust and, with the cooperation of the active material 8 in the presence of oxygen (and/or NO₂), converts this particulate matter into CO₂. Depending on the use and type of washcoat, the active material 8 also converts nitrogen oxides (NOₓ) into nitrogen and oxygen.

In other embodiment forms of the present invention, the layer 3 is not gas-permeable and the flow of exhaust travels in the horizontal direction in FIG. 1. In this case, the support structure is embodied in the form of a flow-through substrate, i.e. the support structure is not open-pored, i.e. does not have gas-permeable pores leading through the walls, but is in any event porous on the surface in order to increase the gas contact area. The device of this kind, referred to as a “flow-through” device, such as an oxidizing converter, in particular a diesel oxidizing converter can, in addition to being made of metal and/or sintered metal, also be manufactured out of silicon carbide or cordierite.

The porosity of the carrying layer S in the example is at least 50%, for example 60%. In particular, it can lie in a range from 55% to 65% (porosity=ratio of empty spaces in the carrying layer in relation to the volume constituted by the outer boundaries of the carrying layer). A porosity of less than 50% is currently assumed to be undesirable because it makes it more difficult to achieve a particularly loose depositing of particulate matter that facilitates its conversion into CO₂. It stands to reason that with a steadily decreasing porosity, the flow resistance of the device increases and that with a porosity that rises significantly above 60%, the ratio of fibers and active material per unit volume of the carrying layer decreases, thus potentially interfering with the desired effect. The upper limit of the porosity is approximately 95%.

The fibers 5 have a diameter in the range from 1 to 10 micrometers, in the above-mentioned exemplary embodiment, a thickness of approximately 5 micrometers. It is advantageous to use fibers with a thickness of 3 micrometers and up because they have a sufficient thermomechanical strength and provide a sufficiently large active surface area. In alternative embodiment forms, it is also possible to provide fibers with a diameter of 1 to 3 micrometers, in particular from 2 to 3 micrometers, which makes it possible to produce a structure with a particularly high porosity. The fibers used have the property of being able to serve as carriers for a catalytic coating, in particular for exhaust treatment in internal combustion engines.

In lieu of individual fibers, whose length in the example varies from approximately 100 μm and 3 mm, it is also possible in some embodiment forms of the present invention to provide fibers with a greater length, which, in order to produce a three-dimensional form of a carrying structure, can then be provided in a wound, woven, crimped, or interlaced arrangement, i.e. in an irregular arrangement or even a regular one (carrying structure with randomly oriented fibers). A woven arrangement can preferably be manufactured in the form of a plain weave, having a first layer of parallel fibers over which is placed a second parallel layer of fibers whose longitudinal direction is offset by 90°, the fibers of which are interwoven with those of the first layer as is done in a plain weave (carrying structure with fibers oriented according to an organizing principle).

The fibers contained in the carrying structure S have an active fiber surface area of at least 1 m² per gram of fiber weight. If rough fibers are used, it is advantageously possible to achieve an active fiber surface area that exceeds the value of 30 m² per gram of fiber weight.

The active material can be any material suitable for particulate matter catalytic converters and/or NOx catalytic converters. In the example, a noble metal-based material, e.g. a platinum-based material, is used as the active material. In addition to the above-mentioned effect when converting particulate matter and NOx, the active material 8 also promotes the conversion of CO into CO₂ and the conversion of hydrocarbons in the exhaust into water and CO₂.

The material of the fibers, ceramic, is Al₂O₃ in the exemplary embodiment. Instead of this or in a mixture with it, TiO₂ and SiO₂ can be provided for the ceramic in some embodiment forms of the present invention. The washcoat can be comprised of the same oxides mentioned above, either as one of the oxides or as a mixture of them. In the example here, Al₂O₃ is also provided.

When the exhaust treatment device is embodied in the form of a wall flow filter, in particular as a sintered metal particulate filter having filter pockets similar to the one described in DE 10301037, the support structure F used preferably has an average pore diameter of greater than 6 micrometers. In this case, the ratio of pores with a pore diameter of greater than 10 micrometers to the overall number of pores in the support structure is greater than 10% and the porosity of the support structure has a value greater than 30%. In a sintered metal particulate filter equipped with filter pockets, in which the walls of the filter pockets are at least partially comprised of an expanded metal screen and sintered metal situated in the openings of the expanded metal screen (see further below), the information above regarding the average pore diameter, the ratio of pores greater than 10 micrometers, and the porosity applies to the regions of the filter pocket walls that are constituted by the open-pored sintered metal. Alternatively, the support structure can also be embodied in the form of a wall flow filter, for example in the form of a silicon carbide filter or in the form of a filter made of cordierite, with corresponding pore dimensions and pore ratios in relation to the overall volume and with the advantage of a low exhaust back pressure paired with a high filtration efficiency.

The manufacturing of this layer that occupies a large volume can, for example, occur in a process that has a single step or two steps: for the process having a single step, the coating is a coating mixture with a high percentage of material fibers, a small percentage of material granules (as bonding agents, among other functions), washcoat additives (in particular TiO₂, SiO₂ and/or Al₂O₃) and optionally, active compounds (catalytically active material). The use of washcoat material makes it possible to eliminate the use of material granules that are comprised, for example, chiefly of aluminum oxide. If necessary or if so desired, the fiber structure can be arranged as a first layer in order to constitute the three-dimensional carrying structure onto which a layer of the material granules plus additives plus active compounds is arranged in a second step. A simple manufacturing process for the three-dimensional carrying layer in the drawing is achieved by producing a slurry of fibers 5 in a suspension of particles of the above-mentioned oxides and the utilized bonding agents in water (or another suitable fluid) so that the fibers and the bonding agent can be applied in a fluid state. The support structure is immersed in the suspension and then withdrawn again. In another possible application method, a slurry is sucked through the filter material. The solids content in a slurry is set so that a washcoat with a suitable thickness forms on the fibers 5 and so that a carrying layer of the desired thickness, which advantageously lies in the range from 0.05 mm to 2.0 mm thick, forms on the support structure. After drying (with or without heat treatment), this layer has interconnected cavities between the individual fibers, which permit diesel engine exhaust to flow through the carrying layer. The dried washcoat material also causes the carrying layer to firmly adhere to the support structure.

In an alternative manufacturing method, in order to manufacture the carrying structure S, the fibers are first applied to the support structure F and in a subsequent step, are provided with bonding agent and bonded to one another.

In partial image a, FIG. 2 shows a top view of an intrinsically known expanded metal screen of the kind that can be used to manufacture an expanded metal/sintered metal filter. It is a flat, smooth metal screen 20 with struts that enclose openings 21. An expanded metal of this kind is a flat material and/or semifinished product with openings in the surface, which are produced by means of offset slits without material loss and simultaneous, stretching deformation. The meshes of the material thus produced, as depicted in partial image a, are usually diamond-shaped, but can also be round or square, and are neither woven nor welded. The material can be cut to any size without losing its strong inherent coherence or breaking up. An expanded metal of this kind that has openings with a cross sectional area of approximately 0.5 to approximately 5 mm² and struts with a width of approximately 0.1 to approximately 1 mm can be used to manufacture a support structure F according to partial image b or an alternative support structure 26 according to partial image c.

Partial image b here shows a view from the side of a longitudinal section through a periodically repeating detail of a support structure F already known from FIG. 1, in which the metallic wall sections 2 are constituted by the expanded metal screen and the rigid layer 3 is comprised of metal powder that is first introduced into the openings 21 of the expanded metal screen and then sintered to the expanded metal; in FIG. 2b and in FIG. 1, this sintered metal powder is depicted in the form of metal balls. In the case of a wall flow filter, the rigid layer 3 comprised of sintered metal has an open-pored structure and a thickness 24 of 0.1 to 0.8 mm, in particular approximately 0.5 mm, that corresponds to the thickness of the expanded metal screen.

In an alternative embodiment form, in lieu of the expanded metal screen, a woven metal fabric can also be used. In another alternative embodiment form, the rigid layer 3 can also be thicker than the expanded metal screen and/or can cover the expanded metal screen; the side of the support structure on which the rigid layer protrudes above the expanded metal screen will be referred to below as the upstream side in an application in which it is used as a filter material.

The alternative support structure 26 according to FIG. 2c, which likewise shows a detail of such a support structure in a longitudinal, sectional view from the side, and is manufactured in a way similar to that used to produce the structure according to FIG. 2b, but with the difference that the openings 21 of the expanded metal screen 2 are not completely filled with sintered metal so that the openings 21 of the expanded metal screen are in fact closed (except for the open-pored structure of the sintered metal regions 3), but in the vicinity of these previous openings, recesses still remain with a clearance 25 above the sintered metal. With a thickness 24 of the expanded metal of 0.5 mm, this clearance 25 lies in a range between 0.2 and 0.4 mm. This only partial filling can be achieved by guiding the expanded metal screen on a soft, elastic roller or a soft die while it is being filled with the sintered metal powder so that the depth of the expanded metal is filled up to a certain percentage. During the filling process, the sintered metal is consequently able to penetrate into the interstices in the expanded screen to an adjustable degree.

FIG. 3 shows a periodically repeating detail of another alternative support structure 35 in which the openings of the expanded metal screen 20 are not filled with a metal powder that has been subsequently sintered, but instead, a sintered metal foil 30 has been applied to one side of the expanded metal screen, in particular pressed onto it. This sintered metal foil, which is metal foil comprised of a mixture of a sintered metal powder and a bonding agent, is applied while it is still “green”, i.e. has not yet been sintered. This metal foil can be manufactured by means of extrusion or casting and is produced in a thickness less than the thickness of the expanded metal screen. After the foil is applied to the expanded metal screen by means of mechanical pressure and heat treatment, in particular by means of being laminated and/or rolled on, a sintering occurs in which the sintered metal is also attached to the expanded metal screen in a nondetachable fashion. The sintered metal foil 30 also has an open-pored structure and the support structure 35 has recesses between the struts of the expanded metal screen similar to the embodiment form of a support structure shown in FIG. 2c.

FIG. 4a shows the upstream side arrangement, already known from FIG. 1, of a fiber layer S on a support structure F. The support structure F in the form of an expanded metal completely filled with sintered metal according to FIG. 2b has a thickness 24 as described above and the fiber layer S has a thickness 42 in the range from 0.05 to 2 mm (see description of FIG. 1). The thickness of the overall structure, which constitutes, for example, the wall of a filter pocket of an exhaust treatment device embodied as a sintered metal filter according to DE 102 23 452 A1, is the sum of the individual thicknesses 24 and 42.

The porosity of the fiber layer can be dimensioned so that it functions as a deep bed filter. This means that the “meshes” of the three-dimensional net formed by the interconnected fibers are very large. This is particularly the case with a porosity of greater than 60 volume percent. Therefore even if a particle “docks” onto a fiber, the large mesh width assures that there is still sufficient space to permit additional particles of particulate matter to pass through the affected pore in the fiber layer. A sufficient thickness of the fiber layer, however, assures that particles have a sufficient probability of being caught as they pass through the fiber layer on a path toward the rigid region 3. The rigid sintered metal region 3, however, is also open-pored, but due to its smaller-diameter pores, functions as a surface filter because a pore becomes clogged as soon as a particle settles in this individual pore.

FIG. 4b shows an arrangement using an alternative support structure 26 according to FIG. 2c in which the openings of the expanded metal screen forming its base are filled only halfway. The original clearance 25 is filled with the fiber layer S. The fiber structure is accommodated inside the expanded metal screen and, on the side oriented away from the rigid regions 3, either does not protrude above the expanded metal screen or only protrudes above it to an insignificant degree. The thickness of the overall structure is essentially determined solely by the thickness 24 of the expanded metal screen used. FIG. 4c shows an arrangement using the additional alternative support structure 35 according to FIG. 3, with the openings of the base expanded metal screen filled only halfway; the openings are filled using a sintered metal foil. With regard to the thickness of the overall arrangement, the explanation given in connection with FIG. 4b also applies here.

In the embodiment forms according to FIGS. 4b and 4c, the interstices of the expanded screen are thus filled with rigid regions in the form of sintered metal not to the full height of the screen, but only up to a certain amount on one side, for example up to half the height 24 of the expanded screen. The remaining space in the screen is then filled with a fiber structure from the other side. The combination of fiber structure and sintered metal is contained within the expanded metal structure. The height of the filling layer (the sum of the sintered metal and the fiber structure) is equal to or not significantly greater than the height of the expanded screen. A slight superelevation by means of the fiber structure can be desirable in order to cover the entire surface area, i.e. not only of the interstices, but also of the struts of the expanded metal screen, with filtering fibers. The filtration efficiency of the combination of the deep bed filtering fiber layer and the surface filter comprised of sintered metal is greater than 90% and, depending on the dimensioning and specific use, can be greater than 99%. The percentage here indicates the proportion of the volumetric flow filtered out. In comparison to the arrangement according to FIG. 4a, the overall thickness of the arrangement is reduced, which results in a comparatively lower exhaust back pressure in the case of a flow-through filtering arrangement. In the case of a sintered metal particulate filter with pockets composed of sintered metal, the filter pockets can therefore be situated closer to one another without falling below a certain minimum distance between the walls of adjacent filter pockets, particularly at the downstream end of a filter according to DE 102 23 452 A1, which can allow the exhaust back pressure to rise slightly.

FIG. 5 shows a partial view of another embodiment form of an exhaust treatment device. Partial image a shows a longitudinal sectional view from the side of the alternative support structure 26, with openings of the expanded metal screen only partially filled with sintered metal, in which the fiber layer S on the side oriented away from the sintered metal has an undulating surface 51. The peaks of the undulating form here are situated above the struts of the expanded metal screen and the valleys of the undulating form are situated between them. The undulating application increases the surface area of the fiber layer in comparison to a flat application. Partial image b shows a corresponding arrangement of a fiber layer S with an undulating surface 51, which is applied to the additional alternative support structure 35 according to FIG. 3.

FIG. 6 shows partial views of longitudinal sections through three examples of additional embodiment forms. The structure according to partial image a includes a carrying base structure or support structure F comprised of expanded metal filled with sintered metal according to FIG. 2b, with a thickness 24. The upstream side of this base structure has a schematically depicted non-woven fabric or fiber mat 60 made of ceramic fibers placed onto it, which is used to filter and store particulate matter. The base material of such intrinsically known non-woven fabrics is a ceramic material, for example aluminum oxide. The thickness 65 of the fiber mat 60 (in the final state, i.e. after attachment to the support structure F) is 0.05 to 2 mm, in particular 0.1 to 0.5 mm. The porosity of the fiber structure is greater than 70%, preferably greater than 85%. The active surface area of the fibers of the fiber mat is greater than 1 m² per gram by weight, preferably greater than 30 m² per gram by weight.

The application of the non-woven fabric to the support structure occurs in process step subsequent to the sintering of the sintered metal-containing support structure F. The bonding of the fiber mat to the sintered metal surface occurs through the use of an inorganic bonding agent based on aluminum oxide sols or silicon oxide sols or a mixture of the two components and a subsequent thermal treatment at approximately 500 to 800° C. for 30 to 60 minutes in an air atmosphere. If the support structure is used to embody filter pockets according to DE 102 23 452 A1, then the non-woven fabric is applied, for example, to the as yet unprocessed expanded metal/sintered metal walls. Alternatively, the non-woven fabric can also be applied to the already formed filter pockets before the final assembly of the filter and in an additional alternative, can be applied to the filter pockets that have already been welded to one another, before final assembly of the filter. In this case, the non-woven fabric is inserted into the upstream interstices between the pockets and applied to the pocket surfaces there.

In partial image b, the non-woven fiber fabric 60 is alternatively applied to a partially filled support structure 26 according to FIG. 2c so that in a fashion similar to the arrangement according to FIG. 5a, an undulating surface 61 is formed on the side of the fiber layer oriented toward the incoming exhaust. In partial image c, an undulating surface 61 of the non-woven fiber fabric 60 (with optionally added catalytically active material) is produced by using a support structure 35 according to FIG. 3, which has a sintered metal foil 30.

1-30. (canceled)

31. An exhaust treatment device for treating the exhaust of an autoignition internal combustion engine of a motor vehicle, the device comprising
a support structure, in which the exhaust is able to interact with the support structure in order to treat the exhaust, and
a fiber layer situated on the surface of the support structure.

32. The exhaust treatment device according to claim 31, wherein the support structure is at least partially comprised of sintered metal.

33. The exhaust treatment device according to claim 31, wherein the support structure has an expanded metal screen or a woven metal fabric, whose openings are at least partially closed with rigid regions comprised of metal.

34. The exhaust treatment device according to claim 33, wherein the rigid regions are comprised of sintered metal powder or a sintered metal foil (30).

35. The exhaust treatment device according to claim 33, wherein the rigid regions have an open-pored structure.

36. The exhaust treatment device according to claim 33, wherein the rigid regions have a height less than the thickness of the metal screen, leaving a clearance above the sintered metal inside the metal screen.

37. The exhaust treatment device according to claim 36, wherein the fiber layer fills the clearance so that the boundary of the fiber layer is flush with that of the expanded metal screen or protrudes slightly above it.

38. The exhaust treatment device according to claim 31, wherein the surface of the fiber layer oriented away from the support structure has a periodic form, in particular an undulating form.

39. The exhaust treatment device according to claim 33, wherein the surface of the fiber layer oriented away from the support structure has a periodic form, in particular an undulating form and wherein the valleys of the undulating form are situated in the vicinity of the rigid regions and the peaks of the undulating form are situated in the vicinity of the metal screen.

40. The exhaust treatment device according to claim 31, wherein the fiber layer is comprised of a non-woven fabric or fiber mat that is applied to the surface of the support structure.

41. The exhaust treatment device according to claim 40, wherein the non-woven fabric or fiber mat is bonded to the support structure by means of a bonding agent, the bonding having been produced by means of a thermal treatment.

42. The exhaust treatment device according to claim 31, wherein the fiber layer has a thickness in the range from approximately 0.05 mm to approximately 2 mm, and preferably from approximately 0.1 mm to approximately 0.5 mm.

43. The exhaust treatment device according to claim 31, wherein the fibers have a diameter of greater than 3 micrometers.

44. The exhaust treatment device according to claim 31, wherein the fibers have a diameter of between 1 and 10 micrometers.

45. The exhaust treatment device according to claim 44, wherein the fibers have a diameter of between 1 and 3 micrometers, and preferably a diameter between 2 and 3 micrometers.

46. The exhaust treatment device according to claim 31, wherein the fibers are bonded to one another, particularly in adjacent regions of the fibers, by means of a bonding agent.

47. The exhaust treatment device according to claim 46, wherein the fibers are at least partially coated with the bonding agent.

48. The exhaust treatment device according to claim 31, wherein at least part of the fibers have open-pored cavities between one another.

49. The exhaust treatment device according to claim 31, wherein the fiber layer has a porosity of at least 50%, and preferably of at least 70%.

50. The exhaust treatment device according to claim 31, wherein the fibers are arranged three-dimensionally.

51. The exhaust treatment device according to claim 31, wherein the fiber layer serves as a carrying structure for a catalytically active material, that is catalytically active for gas/solid reactions and/or for solid/solid reactions.

52. The exhaust treatment device according to claim 51, wherein the catalytically active material promotes an oxidative decomposition of exhaust components.

53. The exhaust treatment device according to claim 46, wherein the fiber layer is bonded to the support structure by means of regions composed of the bonding agent.

54. The exhaust treatment device according to claim 31, wherein the support structure is a gas-permeable open-pored structure.

55. The exhaust treatment device according to claim 31, wherein it is provided for filtering particles, in particular particles of particulate matter, contained in the exhaust.

56. The exhaust treatment device according to claim 41, wherein the bonding agent is a material suitable for washcoats.

57. The exhaust treatment device according to claim 56, wherein the bonding agent contains at least one material from a material group comprised of TiO₂, SiO₂, and Al₂O₃.

58. The exhaust treatment device according to claim 31, wherein the fibers have an active fiber surface area that is greater than 1 m² per gram of fiber weight and preferably greater than 30 m² per gram of fiber weight.

59. In a carrying structure for treating the exhaust of an autoignition internal combustion engine of a motor vehicle, having a support structure, in which the exhaust is able to interact with the support structure in order to treat the exhaust, the improvement wherein the carrying structure is applied to the surface of the support structure and has a fiber layer.

60. A method for manufacturing an exhaust treatment device for treating the exhaust of an autoignition internal combustion engine of a motor vehicle, the method comprising producing a support structure which serves to interact with the exhaust in order to treat the exhaust, and applying a fiber layer onto the surface of the support structure.
